(19) United States
(12) Patent Application Publication
(10) Pub. No.: US 2009/0122817 A1
(43) Pub. Date: May 14, 2009

(54) VARIABLE-WAVELENGTH FILTER AND VARIABLE-WAVELENGTH LASER

(75) Inventors: Kenji Sato, Tokyo (JP); Jan De Merli, Tokyo (JP); Kenji Mizutani, Tokyo (JP); Shinya Sudo, Tokyo (JP); Koji Kudo, Tokyo (JP); Hiroyuki Yamazaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 12/064,441

(22) PCT Filed: Sep. 4, 2006
(86) PCT No.: PCT/JP2006/317463

§ 371 Date: Mar. 21, 2008

(30) Foreign Application Priority Data
Sep. 6, 2005 (JP) 2005-258219

(51) Int. Cl. H01S 3/10; G02B 6/10

(52) U.S. Cl. 372/20; 385/146

(57) ABSTRACT

Only the light at an overlapping wavelength of the transmission characteristics of at least two wavelength selecting filters is looped, and at least one of the wavelength selecting filters varies a selected wavelength. Since a loss due to the optical filters is small and there is not a loss caused by a highly reflecting film, the output of an external-resonator variable-wavelength laser can be increased. Optical circuit component (8) divides light input from external device (1) into at least two ports. Loop waveguide (11) interconnects at least ports (9, 10) divided by optical circuit component (8) in the form of a loop. At least two first wavelength selecting filters (12, 13) are inserted in series in a path of loop waveguide (11), and have periodic transmission characteristics on a frequency axis which are different from each other. At least one of first wavelength selecting filters (12, 13) varies the selected wavelength.

### TECHNICAL FIELD

The present invention relates to an optical filter which is capable of selecting a desired laser oscillation wavelength, and a variable-wavelength laser incorporating such an optical filter.

### BACKGROUND ART

In recent years, as the Internet has been quickly finding widespread use, the communication traffic has grown to the extent that there has been a demand for optical communication systems of greater capacity. To meet such a demand, attempts have been made to increase the number of channels by increasing the transmission rate per channel in the system and also by employing the optical WDM (Wavelength Division Multiplexing) process. The WDM allows a plurality of optical signals having different carrier wavelengths to be transmitted simultaneously over a single optical fiber.

According to the WDM, the communication capacity increases depending on the number of carrier wavelengths (channels) to be multiplexed. For example, if data are modulated at 10 gigabits/second per channel and 100 channels are transmitted over a single common optical fiber, the communication capacity reaches 1 terabits/second.

Recent middle- and long-range optical communications employ the C-band (1530 to 1570 nanometers) that can be amplified by optical fiber amplifiers (EDFA: Erbium-Doped Fiber Amplifiers) 2. The L-band (1570 to 1610 nanometers) may also be employed depending on the type of optical fibers that are used.

Generally, the WDM system need different laser apparatus for respective wavelengths. Therefore, WDM system manufacturers and users have been required to have at hand laser apparatus depending on the wavelengths of standard channels. For example, if 100 channels are involved, then 100 types of laser apparatus are required, resulting in an increase in the cost of inventory control and inventory count.

It has been desired in the field of middle- and long-range communications to put to practical use a single variable-wavelength laser for covering all the wavelengths in the C-band (or L-band). If a single laser apparatus can cover the C-band (or L-band) entirely, then the manufacturers and the users may have such a single laser apparatus at hand, and can greatly reduce the cost of inventory control and inventory count.

It has been desired to construct a flexible network which is capable of setting a dynamic path depending on an increase or decrease in the traffic and the occurrence of a fault. There has also been awaited the development of a network infrastructure which makes it possible to provide a greater diversity of services.

In order to construct an optical communication network having a large capacity, high functionality, and high reliability, a technology for freely controlling wavelengths is indispensable. Variable-wavelength lasers are a highly important key device for the control of wavelengths.

JP-A No. 2003-023208 discloses a variable-wavelength laser comprising a plurality of parallel distribution feedback semiconductor lasers (DFB lasers) having different oscillation wavelengths. The variable-wavelength laser roughly adjusts its wavelength by switching between the lasers and then finely adjusts the wavelength based on a change in the reflective index depending on the temperature. The structure requires an optical coupler for coupling the output ports of the lasers to one optical fiber. If the number of parallel lasers increases, then the optical coupler causes a corresponding increase in its loss. Therefore, there is a tradeoff between the variable wavelength range and the optical output.

Since the variable-wavelength laser based on DFB lasers is capable of fine adjustment of the wavelength depending on the temperature, it can be combined with a wavelength locker disclosed in JP-A No. 2001-257419. The wavelength locker comprises a filter called etalon which develops periodical transmission amplitudes on the frequency axis. In the vicinity of the centers of the transmission amplitudes, an optical intensity that can be detected by a monitored current changes with a highly sensitivity to the laser frequency. Therefore, the wavelength locker can be tuned to a desired frequency. The wavelength locker is an effective means for locking its wavelength to a standard channel wavelength highly accurately.

One variable-wavelength laser which is capable of meeting the requirements for wavelength control while being free from the above tradeoff is an external-resonator variable-wavelength laser. Intensive research and development efforts are being made with respect to such an external-resonator variable-wavelength laser. The external-resonator variable-wavelength laser includes a resonator comprising a semiconductor optical amplifier (SOA) and an external reflecting mirror, and a variable-wavelength filter inserted in the resonator for selecting a wavelength. The external-resonator variable-wavelength laser relatively easily provides a variable-wavelength range for covering the entire C-band.

Most of the basic characteristics of the variable-wavelength laser of the above type are determined by the variable-wavelength filter. Therefore, various variable-wavelength filters having excellent characteristics have been developed. For example, the developed variable-wavelength filters include a filter as a rotatable etalon disclosed in JP-A No. 04-69987, a filter as a rotatable diffraction grating disclosed in JP-A No. 05-48220, and an acoustic filter and a dielectric filter disclosed in JP-A No. 2000-261086.

There are various external-resonator variable-wavelength lasers employing such variable-wavelength filters and mirrors. In particular, an arrangement including, in addition, to a gain medium, a periodic channel selecting filter, a variable-wavelength filter, and a reflecting mirror is effective in realizing a high-performance light source. For example, an etalon having periodic frequency characteristics is used as the periodic channel selecting filter. An acoustic filter is used as the variable-wavelength filter. An electrically controlled variable-wavelength mirror or the like is used as the variable-wavelength mirror.

The light output from the gain medium of a semiconductor optical amplifier or the like contains a number of Fabry-Perot modes. Of these modes, only a mode agreeing with the periodic pass band of the channel selecting filter passes through the channel selecting filter. Since the Fabry-Perot modes which cannot pass through the channel selecting filter are suppressed, auxiliary modes can relatively easily be suppressed even if the intervals between the Fabry-Perot modes are relatively small, i.e., even if the external resonator has a relatively large overall length. It is possible with this arrangement to realize wavelength selecting characteristics according to a relatively simple control process.

In the above arrangement, the transmission wavelength of the periodic channel selecting filter is fixed, and the transmission peak thereof is in agreement with a standard channel for optical communications. As the channel selecting filter is disposed in the external resonator, the wavelength accuracy in the channel accuracy of the channel selecting filer is obtained without the wavelength locker which is required in the variable-wavelength DFB laser.

The external resonator, which has an external wavelength varying mechanism, has its mode tending to become unstable due to vibrations. Consequently, a structure including a wavelength varying mechanism disposed in a semiconductor device is also used in general. According to one typical example, an active region for producing a gain and a DBR (Distributed Bragg Reflector) passive region for producing a reflection by means of a diffraction grating are formed in one semiconductor device. The DBR region can change the reflection wavelength by introducing a current to change the refractive index of a waveguide in the semiconductor.

However, the change in the refractive index in the semiconductor of ordinary DBR lasers produces a variable wavelength range of 10 nanometers at most. JP-A No. 07-153933 discloses a variable-wavelength laser wherein front and rear portions of the gain region are sandwiched by slightly different DBR regions. The DBR regions which are used are capable of obtaining a plurality of reflection peaks at constant wavelength intervals. Only one reflection peak overlaps simultaneously by setting the wavelength intervals to slightly different values at the front and rear portions of the gain region.

The above effect is referred to as so-called “Vernier effect”. According to this effect, simply by slightly changing the refractive index of one of the DBR regions, overlapping reflection peaks can be moved to a next reflection peak to change the wavelength in a wide range. It has been reported that the wavelength can be changed in excess of 100 nanometers by the this effect.

However, the technology which utilizes the “Vernier effect”, such as the DBR laser, has the following problems:

The DBR laser on the above operating principles produces the “Vernier effect” with the DBR regions disposed in the front and rear portions of the gain region. Generally, the DBR region in the front portion has high reflection characteristics which make it impossible to increase the front optical output that is transmitted through the DBR region. Therefore, it has been difficult to put the laser to practical use. Furthermore, as the size of the semiconductor device is large for realizing the operating principles, the price is high because the price is essentially determined by the semiconductor size according to the semiconductor technology.

Some of the above problems may be solved by a variable-wavelength filter comprising a plurality of ring resonators described in “ECOC (European Conference to Optical Communication) 2004, collected preprints, Yamazaki, et al., Th4.2.4”. According to this literature, the “Vernier effect” can be realized for obtaining wavelength varying operation in a wide range by combining two ring resonators having different circulatory lengths.

FIG. 1 is a view showing an example of the structure of a variable-wavelength filter having a plurality of ring resonators. As shown in FIG. 1, two ring resonators 57, 58 having different optical path lengths are connected to each other by an optical coupling means, making up multiple ring resonator 25. Multiple ring resonator 25 has first port 51 constructed as a waveguide connected to external SOA device 56 by an optical coupling means. Nonreflecting coating 54 is applied to the end face of first port 51. Multiple ring resonator 25 has second port 53 opposite to first port 51, and highly reflecting coating 55 is applied to the end face of second port 53.

One ring resonator has a periodic passband whose period is determined by the circulatory length of the ring. If the waveguide has effective refractive index n, then the period (FSR: Free Spectral Range) of the passband of a ring resonator whose circulatory length is L expressed by the equation (1):

$$\begin{matrix}[ Equation 1 ] & \\ F S R = \frac{C}{2 nL} & ( 1 )\end{matrix}$$

where C represents the speed of light.

For example, since a silica waveguide has refractive index n=1.5, if first ring resonator 57 has circulatory length L1=4 millimeters, then the passband has period SR1=50 gigahertz. If second ring resonator 58 has circulatory length L2=3.96 millimeters, then the passband has period SR2=50.5 gigahertz.

Accordingly, the period of the passband of multiple ring resonator 52 made up of two ring resonators 57, 58 is 5050 gigahertz (about 40 nanometers) which is the least common multiple of periods SR1, SR2. This period is defined as FSR of the multiple ring resonator. As FSR of first ring resonator 57 is 50 gigahertz, it operates as a filter for setting a periodic channel due to the same effect as the etalon having the structure shown in FIG. 1 of JP-A No. 2000-261086.

When the wavelength band of second ring resonator 58 is changed on the wavelength axis, the overall structure shown in FIG. 1 operates as a variable-wavelength filter for selecting channels.

One advantage that is obtained by using the Vernier effect is that wavelength varying operation can be performed in a wide range by a small change in the refractive index. As described in “ECOC (European Conference to Optical Communication) 2004, collected preprints, Yamazaki, et al., Th4.2.4” referred to above, when the refractive index of the waveguide is changed by a thermooptical effect developed by changing the temperature of a ring resonator, to change the overlapping wavelengths of the first and second ring resonators, the transmission wavelength can be changed by the Vernier effect.

According to another advantage obtained by using the Vernier effect, the wavelength varying band can be increased. FSR of multiple ring resonator 52 can be set to a sufficiently large value by making large the least common multiple of period FSR1 of the passband of first ring resonator 57 and period FSR2 of the passband of second ring resonator 58.

### DISCLOSURE OF THE INVENTION

The structure shown in “ECOC (European Conference to Optical Communication) 2004, collected preprints, Yamazaki, et al., Th4.2.4” referred to above has the following problems:

The first problem is that it is not suitable for increasing the output of the laser. The reasons for this will be described below.

Light from semiconductor device 56 travels from nonreflecting coating film 54 through first port 51, multiple ring resonator 52, and second port 53 to highly reflecting film 55, and then is reflected by highly reflecting film 55 to travel back along the same path. The return path extends from highly reflecting film 55 through second port 53, multiple ring resonator 52, and first port 51 to nonreflecting film 54.

Multiple ring resonator 52 obtains desired characteristics only when light passes. Therefore, after the light from first port 51 is transmitted through multiple ring resonator 52 to select a wavelength, the light is returned again to first port 51. The light needs to be reflected by the end face which is coated with highly reflecting film 55 and transmitted through multiple ring resonator 52. As a result, the number of times that the light passes through the ring resonators is increased. Since a certain optical loss occurs each time the light passes through a ring resonator, a large optical loss is caused when the light travels in one direction and the other through multiple ring resonator 52, resulting in a reduction in the laser output.

Actually, highly reflecting film 55 does not reflect 100% of the optical power, but allows several % of the optical power to be emitted out, rather than being reflected. Such a light emission also causes an optical loss.

The fabrication of such a variable-wavelength filter requires highly reflecting film 55 to be formed on the end face of second port 53. Therefore, the fabricating cost is high because the fabricating process is complex.

The second problem is that the oscillation mode of the laser tends to be unstable. The reasons for this will be described below.

Multiple ring resonator 52 has a large overall wavelength length because it has a ring structure through which light circulates. Therefore, laser mode intervals are extremely small, tending to make the laser oscillation mode unstable. With the structure shown in FIG. 1, for example, since the waveguide length of multiple ring resonator 52 is 15 millimeters or more and the mode intervals are defined together with the SOA length, the mode intervals are in the range from 4 to 5 gigahertz, bringing the adjacent modes closely to each other.

The third problem is that the frequency modulation (FM) efficiency is low. This is because the laser oscillation wavelength is locked to first ring resonator 57, i.e., the periodic channel selecting filter, as will be described in detail below.

First ring resonator 57 is of a structure, such as of an etalon, where resonance is caused therein. In the vicinity of a wavelength which is transmitted mostly, the light circulates the greatest number of times in the ring resonator. Consequently, the effective optical path length is much greater than circulatory length L1. As a result, the wavelength varies slowly for the laser phase control, i.e., the adjustment of the optical path length.

It is known in the art of optical fiber communications in recent years that the laser oscillation wavelength is intentionally frequency-modulated to suppress stimulated Brillouin scattering (SBS) in an optical fiber for thereby reducing an optical loss in the optical fiber. If a channel selecting filter wherein the wavelength varies slowly as described above is employed, then the frequency modulation efficiency is lowered. If excessive frequency modulation operation is unduly carried out, then since the laser beam intensity is greatly modulated due to the sharp filter characteristics, the signal light is intensity-modulated beyond an allowable range, tending to cause a communication error. Accordingly, no sufficient frequency modulation can be performed, and hence SBS cannot sufficiently be suppressed, so that the loss in the optical fiber is increased to hamper long-distance communications.

It is an object of the present invention to provide an external-resonator variable-wavelength laser which incorporates a multiple ring resonator which is high in laser mode stability, optical output, and frequency modulation efficiency, and which is low in cost and small in size.

To achieve the above object, there is provided in accordance with the present invention a variable-wavelength filter for varying a wavelength at which light is transmitted, comprising an optical circuit and a loop waveguide.

The optical circuit component divides light input from an external device into at least two ports. The loop waveguide interconnects at least the ports divided by the optical circuit component in the form of a loop. At least two first wavelength selecting filters are inserted in series in a path of the loop waveguide, the first wavelength selecting filters having periodic transmission characteristics on a frequency axis which are different from each other. At least one of the first wavelength selecting filters being capable of varying a selected wavelength.

In the variable-wavelength filter according to the present invention, the optical circuit component divides and inputs the light to the loop waveguide, and the loop waveguide loops and returns only the light at an overlapping wavelength of the transmission characteristics of at least two wavelength selecting filters. Since a loss due to the optical filters is small and there is not a loss caused by a highly reflecting film, the output of the laser can be increased. The manufacturing cost is reduced because there is no step of forming a highly reflecting film. As the entire waveguide length is shorter than heretofore, the oscillation mode of the laser is stabilized, and the frequency modulation efficiency is improved.

### BRIEF DESCRIPTION OF THE DRAWINGS

FIG. 1 is a view showing an example of the structure of a variable-wavelength filter having a plurality of ring resonators;

FIG. 2 is a schematic view showing the structure of an external-resonator variable-wavelength laser according to a first exemplary embodiment;

FIG. 3 is a block diagram conceptually showing the structures of ring resonators;

FIG. 4 is a schematic view showing the structures of external-resonator variable-wavelength lasers according to various modifications of the first exemplary embodiment;

FIG. 5 is a schematic view showing the structures of external-resonator variable-wavelength lasers according to various modifications of the first exemplary embodiment;

FIG. 6 is a schematic view showing the structure of an external-resonator variable-wavelength laser according to a modification of the first exemplary embodiment;

FIG. 7 is a schematic view showing the structure of an external-resonator variable-wavelength laser according to a modification of the first exemplary embodiment;

FIG. 8 is a block diagram conceptually showing the structures of external-resonator variable-wavelength lasers incorporating a slanted waveguide as a first port;

FIG. 9 is a block diagram conceptually showing the structure of an external-resonator variable-wavelength laser incorporating a slanted end-face waveguide between a phase adjusting region and a nonreflecting coating;

FIG. 10 is a timing chart illustrative of operation of the external-resonator variable-wavelength laser;

FIG. 11 is a schematic view showing the structure of a variable-wavelength filter substrate according to a second exemplary embodiment;

FIG. 12 is a schematic view showing the structure of a variable-wavelength filter substrate according to a third exemplary embodiment;

FIG. 13 is a schematic view showing the structure of an external-resonator laser with an integrated variable-wavelength filter according to a fourth exemplary embodiment; and

FIG. 14 is a flowchart showing a process of adjusting temperature under current control according to the fourth exemplary embodiment.

### BEST MODE FOR CARRYING OUT THE INVENTION

Exemplary embodiments of the present invention will be described in detail below with reference to the drawings.

### 1st Exemplary Embodiment

FIG. 2 is a schematic view showing the structure of an external-resonator variable-wavelength laser according to a first exemplary embodiment. As shown in FIG. 2, the external-resonator variable-wavelength laser basically comprises semiconductor device 1 and variable-wavelength filter substrate 6.

Semiconductor device 1 includes phase adjusting region 3 integrated as a passive component in combination with semiconductor optical amplifier 2 as an active component. Semiconductor device 1 has an optical output side where semiconductor optical amplifier 2 is located. Lowly reflecting coating 4 (having a reflectance ranging from 1% to 10%) is applied to the end face of the optical output side. Semiconductor device 1 has an external resonator side where phase adjusting region 3 is located. Nonreflecting coating (1% or less) is applied to the end face of the external resonator side. Semiconductor device 1 may have an optical output side where phase adjusting region 3 is located.

Semiconductor optical amplifier 2 comprises a multiple quantum well (MQW), and generates and amplifies light when a current is introduced thereinto.

Phase adjusting region 3 comprises a bulk composition or a multiple quantum well, and has a band gap set to a wide gap which is small enough not to absorb laser oscillation light. When a current is introduced or a voltage is applied, the refractive index of phase adjusting region 3 is varied to change the phase of the laser beam.

Semiconductor optical amplifier 2 and phase adjusting region 3 may be fabricated according to the known butt joint technology or the known selective growth technology.

Semiconductor optical amplifier 2 and phase adjusting region 3 are electrically sufficiently spaced from each other so that their currents will not interfere with each other. Specifically, semiconductor optical amplifier 2 and phase adjusting region 3 are spaced from each other by a separating resistor of 1 kilohms or higher.

Variable-wavelength filter substrate 6 is disposed and coupled in abutment against the external resonator side of semiconductor device 1. Normally, the distance between semiconductor device 1 and variable-wavelength filter substrate 6 is in the range from several microns to several tens microns.

Variable-wavelength filter substrate 6 has first port 7 for entering light from and outputting light to outside of the substrate. First port 7 is optically coupled to 1×2 optical demultiplexer 8 to which second port 9 and third port 10 are connected. Second port 9 and third port 10 are optically coupled into a loop serving as loop waveguide 11. First ring resonator 12 and second ring resonator 13 are disposed in loop waveguide 11.

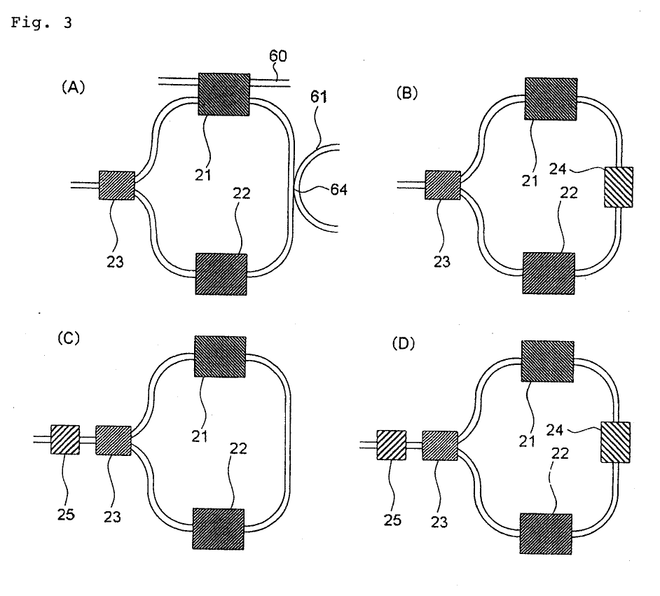

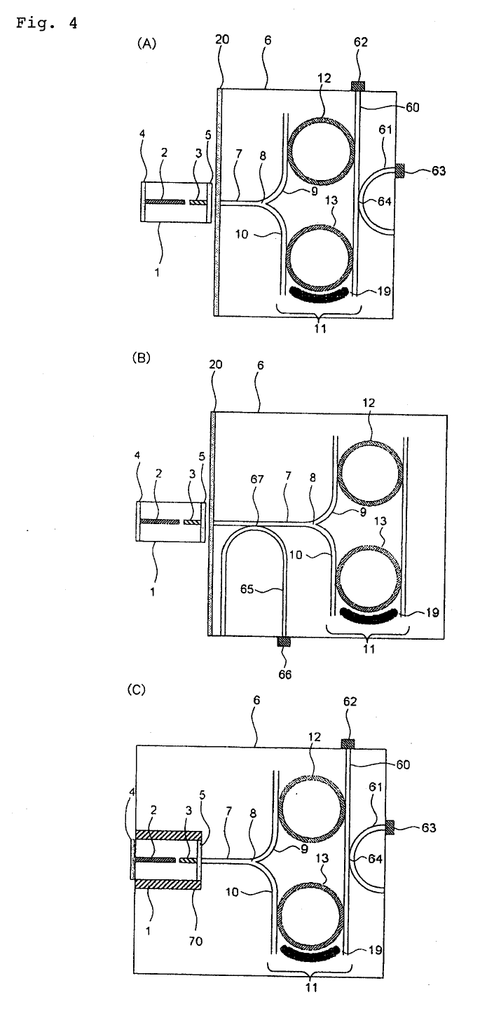

In FIG. 2, each of first ring resonator 12 and second ring resonator 13 has a ring resonator structure. The ring resonator structure may be illustrated in a conceptual block diagram shown in FIG. 3(A). As shown in FIG. 3(A), the ring resonator structure includes 1×2 optical demultiplexer 23, first optical filter 21, and second optical filter 22 which are coupled on a loop. Furthermore, first monitoring waveguide 60 is connected to first optical filter 21. 2×2 optical demultiplexer 64 is disposed between first optical filter 21 and second optical filter 22, and second monitoring waveguide 61 is connected to 2×2 optical demultiplexer 64. In FIG. 3(A), each of first filter 21 and second filter 22 comprises a transmissive filter having two ports, or specifically, ring resonators 12, 13 shown in FIG. 2 or an AWG filter or the like.

The structure shown in FIG. 2 will be described more specifically.

First ring resonator 12 and second ring resonator 13 shown in FIG. 2 have different characteristics. In FIG. 2, FSR of first ring resonator 12 is set to FSR1=50.0 gigahertz. In other words, the circulatory length of the ring is 4 millimeters. FSR of second ring resonator 13 is set to FSR2=50.5 gigahertz. In other words, the circulatory length of the ring is 3.96 millimeters. The finesse (the ratio of the pass peak band to FSR) of the ring resonators may be of a value in the range from 2 or 3 to several tens as normally used, and is not particularly stipulated. The values of FSR1, FSR2 of first and second filters 12, 13 are given by way of example only, and are not of restrictive nature.

For example, RSR1, RSR2 may be set to FSR1=500 gigahertz and FSR2=505 gigahertz. In this case, the circulatory lengths of the rings are 0.4 millimeter and 0.396 millimeter, respectively. If such small rings are realized, then since the difference between the refractive indexes of the waveguide core layer and the cladding layer of the silica waveguide referred to above is so small that the optical confinement is weak, a large loss is caused by a bent waveguide. It is more effective to use a silicon waveguide on an SOI (Silicon On Insulator) which is capable of increasing the optical confinement ratio because the loss at the bent waveguide can be reduced. In such a case, since the refractive index of the waveguide core is high, the circulatory lengths of the rings are further reduced to 0.2 millimeter or less, resulting in an advantage in that the size of the variable-wavelength filter is reduced. On semiconductors and SOIs, FSR may be made greater than FSR=500 gigahertz because of the high waveguide refractive index, making it possible to realize a smaller variable-wavelength filter.

The components of semiconductor device 1 are placed on one temperature controller (TEC: Thermo-Electric Cooler), so that they are temperature-controlled. A thermistor for monitoring temperatures, a PD (PhotoDiode) for monitoring the optical output, etc. are placed in appropriate positions.

A microheater for changing the temperature of the ring resonator, which is of general nature, is laid on first ring resonator 12. A microheater may also be laid on second ring resonator 13. The laying of microheaters is described in “ECOC (European Conference to Optical Communication) 2004, collected preprints, Yamazaki, et al., Th4.2.4”.

In the present exemplary embodiment, the temperatures of the first and second filters may be varied simultaneously, or the temperature of only one of the first and second filters may be varied. If the temperature of only one of the first and second filters is varied, it is preferable to change the temperature of the ring resonator whose FSR is not 50 gigahertz, i.e., the temperature of second ring resonator 13. The ring resonator whose FSR is 50 gigahertz, i.e., the first ring resonator 12, may be kept in agreement with the standard channel. By varying the temperature of at least one of the optical filters, the transmission spectrum is changed thereby to change the overlapping frequency of the transmission spectrums of the two filters, so that a variable-wavelength laser can be realized. In FIG. 2, the temperature of second ring resonator 13 can be changed by resistance heater 19. If FSR1=500 gigahertz and FSR2=505 gigahertz and the variable-wavelength laser is used in a system wherein channel intervals are 500 gigahertz, then the temperatures of both rings have to be regulated. It is desirable to individually monitor the temperatures of the rings for highly accurate control.

If an optical filter is realized on a semiconductor or an SOI, then a change in the refractive index which is caused by introducing a current into the optical filter may be utilized, in addition to utilizing a change in the temperature caused by a resistance heater. In such a case, the refractive index may be changed by heating caused by the current. Therefore, when a current is introduced into an optical fiber, it is desirable to individually monitor the temperatures of the rings for highly accurate control.

FIG. 4(A) shows a modification of the first exemplary embodiment. In FIG. 4(A), first monitoring waveguide 60 from first optical ring resonator 12 reaches an end face of variable-wavelength filter substrate 6. First monitoring PD 62 is mounted on the end face.

2×2 optical demultiplexer 64 is disposed on loop waveguide 11, and second monitoring waveguide 61 which is connected to 2×2 optical demultiplexer 64 reaches an end face of variable-wavelength filter substrate 6. Second monitoring PD 63 is mounted on the end face.

When the transmission peaks of first and second ring resonators 12, 13 overlap each other, if the laser oscillation wavelength is brought into agreement with the transmission peak wavelength by the adjustment of phase adjusting region 3, then the power monitored by first monitoring PD 62 becomes nil. In other words, when first monitoring PD 62 detects an optical power level higher than nil, it means that the laser oscillation wavelength is spaced from the standard optical channel determined by first ring resonator 12. Therefore, the laser oscillation wavelength can be monitored based on the optical power detected by first monitoring PD 62.

Second monitoring PD 63 simply monitors inside optical power. The inside optical power is maximized when the transmission peaks of first and second ring resonators 12, 13 overlap each other and the laser oscillation wavelength is brought into agreement with the transmission peak wavelength.

Therefore, the oscillation wavelength can be set to the standard channel by performing phase control to make the optical power detected by first monitoring PD 62 nil and to maximize the optical power detected by second monitoring PD 63.

First monitoring waveguide 60 and second monitoring waveguide 61 are perpendicular to an end face of variable-wavelength filter substrate 6. However, they may be arranged to emit the light at an angle rather than a right angle in order to reduce reflections from the end face.

A port of first monitoring waveguide 60 which is opposite to second monitoring port 63 across 2×2 optical demultiplexer 64 may be used as a monitoring port. To this end, a new monitoring PD may be provided or second monitoring PD 63 that has already been provided may be used in common.

Similarly, an unused port (a port which is an extension of second port 9) which is opposite to first monitoring PD 62 across first ring resonator 12 may be extended to an end face of variable-wavelength filter substrate 6, and a new monitoring PD may be provided. Alternatively, first monitoring PD 62 that has already been provided may be used in common.

FIG. 4(B) shows another modification of the first exemplary embodiment. In FIG. 4(B), 2×2 optical demultiplexer 67 is disposed on first port 7, and monitoring waveguide 65 connected to 2×2 optical demultiplexer 67 reaches the end face of variable-wavelength filter substrate 6. Monitoring PD 66 is mounted on the end face. The present arrangement wherein the monitoring PD is disposed on first port 7 is capable of monitoring the light in the same manner as with the arrangement wherein the monitoring PD is disposed loop waveguide 11.

FIG. 4(C) shows still another modification of the first exemplary embodiment. In FIG. 4(C), the assembly is packaged such that semiconductor device 1 is directly connected to first port 7. With this structure, the assembly can be packaged easily, and the assembling cost can be reduced. Pattern 70 for passive alignment may be disposed on variable-wavelength filter substrate 6, and semiconductor device 1 may directly be mounted without passing a current therethrough.

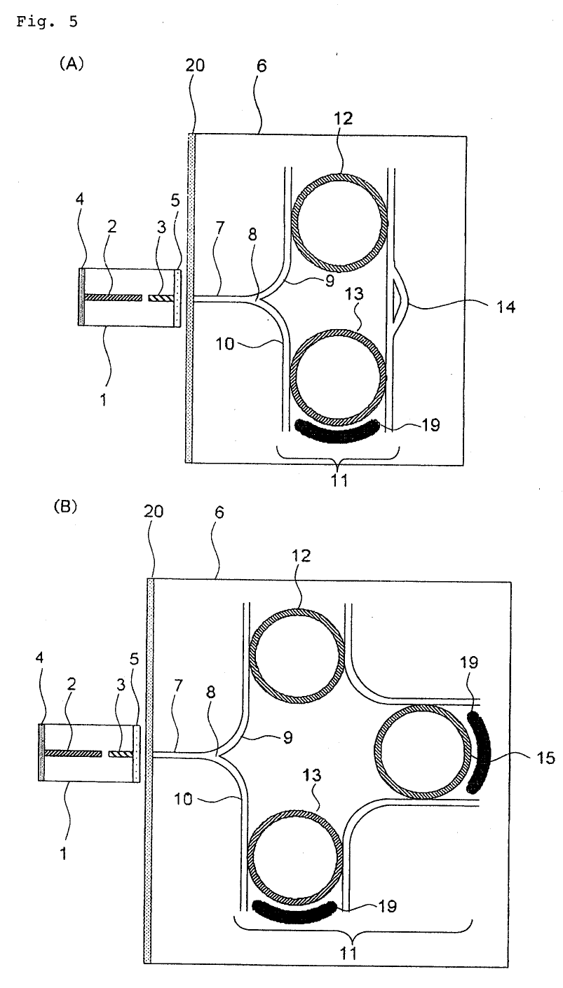

FIG. 5(A) shows yet another modification of the first exemplary embodiment. In FIG. 5(A), an asymmetrical Mach-Zehnder interferometer 14 is disposed on a waveguide which interconnects first ring resonator 12 and second ring resonator 13.

In FIG. 5(A), asymmetrical Mach-Zehnder interferometer 14 comprises an asymmetrical Mach-Zehnder-type interferometer. The Mach-Zehnder interferometer makes slightly different the optical path lengths of the two optical waveguides that are branched at the ratio 1×2, producing an interference effect. Based on the interference effect, FSR is set to a large value on the order of 5 terahertz, providing a structure which is essentially free of deteriorations in the variable wavelength band that is used. The addition of asymmetrical Mach-Zehnder interferometer 14 is effective to suppress laser oscillations at 5050 gigahertz where the transmission spectrums of the first and second optical filters will agree with each other, so that the laser oscillation mode is made stabler.

A structure with a third optical filter is illustrated in a conceptual block diagram show in FIG. 3(B). As shown in FIG. 3(B), third optical filter 24 is disposed on a waveguide which interconnects first optical filter 21 and second optical filter 22. In FIG. 3(B), third optical filter 24 may comprise a ring resonator. In such a case, FSR of the ring resonator needs to be different from FSRs of first and second ring resonators 12, 13, and should preferably be of a value greater than FSRs of first and second ring resonators 12, 13.

FIG. 5(B) shows a modification wherein a third filter comprises a ring resonator. In FIG. 5(B), FSR of third ring resonator 15 is set to FSR3=45 gigahertz, and resistance heater 19 provides a wavelength varying function.

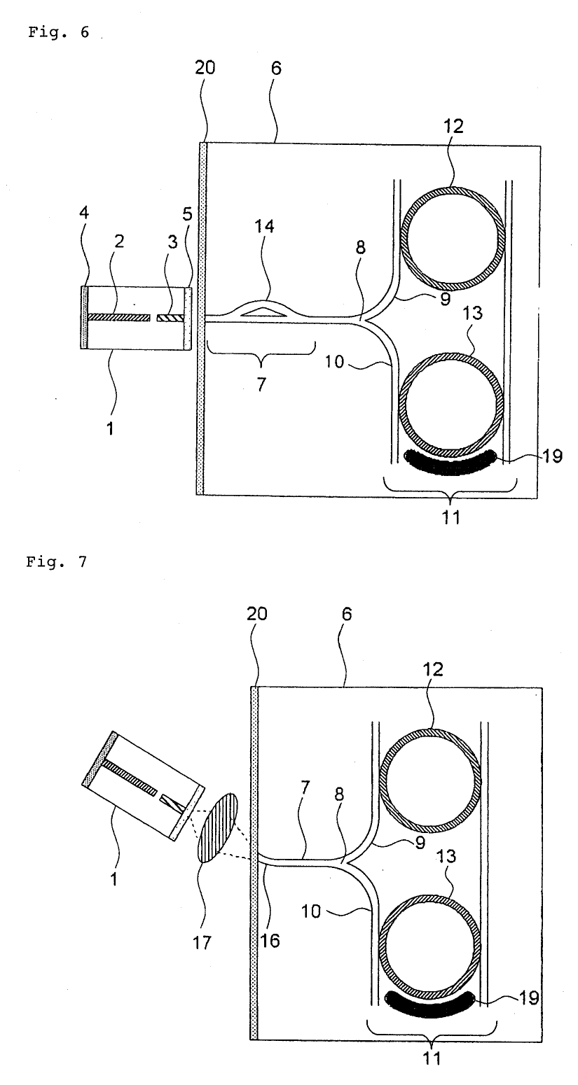

Yet still modification of the first exemplary embodiment is shown in FIG. 6, and functions in the same manner as with the structure shown in FIG. 5(A). In FIG. 6, asymmetrical Mach-Zehnder interferometer 14 is disposed on first port 7. The structure shown in FIG. 6 may be illustrated in a conceptual block diagram shown in FIG. 3(C). In FIG. 3(C), asymmetrical Mach-Zehnder interferometer 14 shown in FIG. 6 is represented as fourth optical filter 25 in FIG. 3(C). FIG. 3(C) shows an arrangement which is free of third optical filter 24. However, as shown in FIG. 3(D), third optical filter 24 may be provided in addition to fourth optical filter 25.

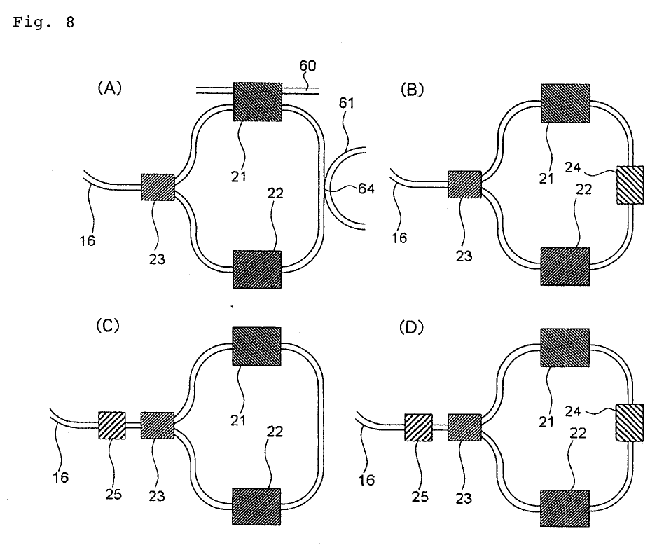

In the present exemplary embodiment, nonreflecting coating 20 may be applied to the end face of variable-wavelength filter substrate 6 near first port 7. As shown in FIG. 7, known slanted end-face waveguide 16 may be included in first port 7 for further reducing the reflectance of the end face. Semiconductor device 1 and variable-wavelength filter substrate 7 are coupled to each other by coupling lens 17. Conceptual block diagrams of variable-wavelength filter substrate 6 with slanted waveguide 16 included therein are shown in FIGS. 8(A) through 8(D). The structures shown in FIGS. 8(A) through 8(D) are capable of reducing reflections at the input of the variable-wavelength filters in the variable-wavelength lasers shown in FIGS. 3(A) through 3(D).

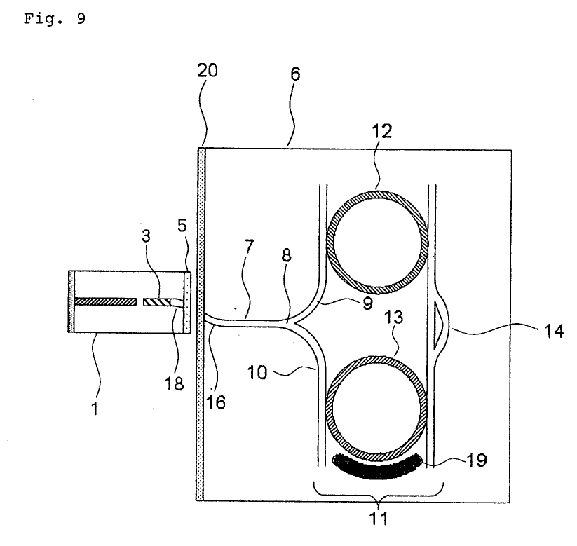

In the present exemplary embodiment, slanted end-face waveguide 18 may be provided between phase adjusting region 3 and nonreflecting coating 5 as shown in FIG. 9 for further reducing the reflectance of the coating on the external resonator side of semiconductor device 1. The arrangement shown in FIG. 9 is effective to make the mode stabler.

In the present exemplary embodiment, a known wavelength locker may be provided outside of the resonator. Since the wavelength locker passes only light at a desired wavelength, the wavelength accuracy is further increased.

The structure according to the present exemplary embodiment may be provided on a silica waveguide or may be provided on a semiconductor, an SOI, or a polymer. If the structure is provided on a semiconductor or an SOI, then since a waveguide having a refractive index higher than silica is produced, the size of the filter is smaller than an equivalent filter.

In the present exemplary embodiment, 1×2 optical demultiplexer 8 may be a known 2×2 MMI (multimode interference) coupler. If a 2×2 MMI coupler is employed, then only one of the two input ports may be used.

Basic wavelength operation principles of the external-resonator variable-wavelength laser, constructed as described above, according to the first exemplary embodiment will be described below.

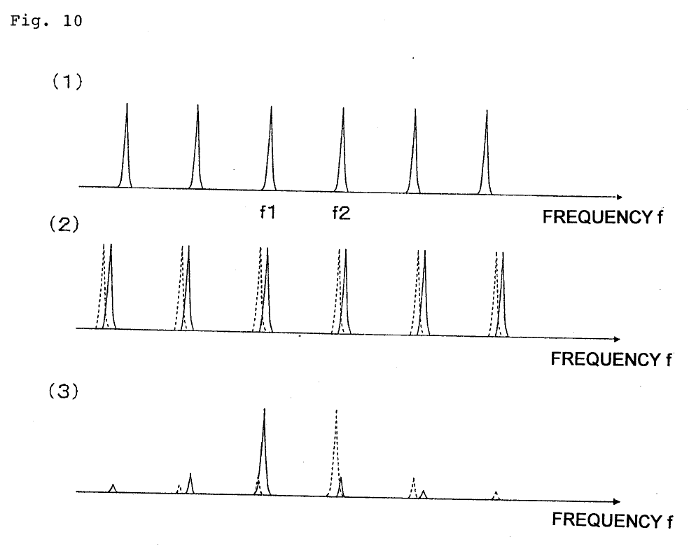

FIG. 10 is a timing chart illustrative of operation of the external-resonator variable-wavelength laser. In FIG. 10, (1) shows the optical transmission spectrum on the frequency axis of one of two different optical filters which has a smaller FSR, e.g., the optical transmission spectrum of first ring resonator 12 shown in FIG. 2. (2) shows the optical transmission spectrum on the frequency axis of the different optical filter which has a greater FSR, e.g., the optical transmission spectrum of second ring resonator 13 shown in FIG. 2. Second ring resonator 13 can have its optical transmission spectrum variable under temperature control. Two optical transmission spectrums represented by the solid and broken lines are shown in (2). (3) shows the optical transmission spectrum produced when the spectrums shown in (1), (2) overlap each other. The optical transmission spectrum shown in (3) represents an optical transmission spectrum produced when first optical ring resonator 12 and second optical ring resonator 13 are optically connected in series to each other. The solid and broken lines in (3) correspond respectively to the solid and broken lines in (2).

As shown in (1) and (2), the intervals (FSR) of a number of periodic transmission peaks of first and second optical ring resonators 12, 13 are slightly different from each other. For example, FSR1 of first optical ring resonator 12 is set to 50 gigahertz, and FSR2 of second optical ring resonator 13 is set to 50.5 gigahertz. In other words, the circulatory length of the ring resonator as first optical filter 12 is set to 4 millimeters, and the circulatory length of the ring resonator as second optical filter 13 is set to 3.93 millimeters.

It is assumed that, as indicated by the solid lines in (2), the transmission peak of first optical ring resonator 12 and the transmission peak of second optical ring resonator 13 agree with each other at frequency f1. At this time, the spectral overlap of the two series-connected optical ring resonators is the greatest at frequency f1 and is smaller at the frequencies other than frequency f1, as indicated by the solid lines in (3). The next greatest spectral overlap occurs at 5050 gigahertz which is the least common multiple of FSR1 and FSR2. The frequency of 5050 gigahertz corresponds to a wavelength of about 40 nanometers. Since the variable wavelength range that is used is ±20 nanometers, the frequency of 5050 gigahertz does have essentially no effect.

Wavelength varying operation will be described below. It is assumed that the refractive index of the waveguide of second optical ring resonator 13 is changed in some way. For example, the refractive index of the waveguide of a ring resonator disposed on a silica waveguide may be changed by a mechanism comprising a film heater placed on the ring resonator, as described in ECOC (European Conference to Optical Communication) 2004, collected preprints, Yamazaki, et al., Th4.2.4. In FIG. 2, resistance heater 19 corresponds to such a heater.

When the temperature of the waveguide is increased, the refractive index of the silica waveguide normally rises. The optical transmission spectrum shown in (2) of FIG. 10 slightly shifts into a lower frequency range from the solid lines toward the broken lines. As a result, the transmission peak frequencies of the first and second optical filters are brought into agreement with each other at frequency f2.

The optical transmission spectrum produced by the two series-connected optical ring resonators indicates that the light is transmitted only at frequency f2 as indicated by the broken lines in (3) of FIG. 10. By thus simply changing the frequency by Δf=FSR2−FSR1 in (2), the frequency of the spectral overlap in (3) can be changed from f1 to f2. For example, when the frequency is changed by Δf=0.5 gigahertz, the frequency of the spectral overlap is changed by f2−f1=50 gigahertz, which is about 100 times greater than 0.5 gigahertz.

When the above control process is repeated, the frequency can be changed, though not continuously, in a very wide range. The above process is based on the same principles as a slide caliper dial or a Vernier dial which was used to change the frequency in old communication devices. In addition, if not only second optical ring resonator 13, but also first optical ring resonator 12, is operated to change the frequency, then the frequency can be changed continuously in a very wide range.

According to the present exemplary embodiment, a variable-wavelength filter comprising a periodic wavelength selecting filter which utilizes the transmission characteristics of a ring resonator does not need to have a high-reflectance end-face coating which has heretofore been required. As shown in FIG. 2, variable-wavelength filter substrate 6 of the variable-wavelength laser according to the present exemplary embodiment includes first port 7 and 1×2 optical demultiplexer 8 that is optically connected to first port 7. Second port 9 which is opposite to first port 7 and third port 10 are optically coupled into a loop serving as loop waveguide 11.

Two ring resonators 12, 13 having different periodic frequency characteristics for utilizing the Vernier effect are disposed in loop waveguide 11. In FIG. 2, 1×2 optical demultiplexer 8 divides the optical energy into two beams. One of the beams is propagated from second port 9 to first and second ring resonators 12, 13, thereafter travel through third port 10 back to 1×2 optical demultiplexer 8, from which it is finally output to first port 7.

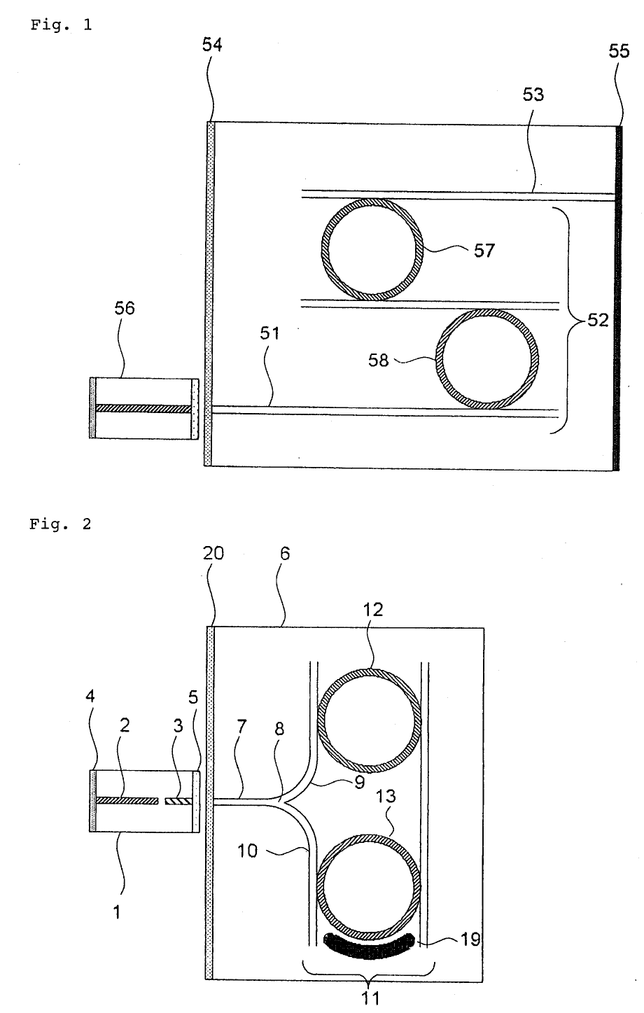

Similarly, the other beam from 1×2 optical demultiplexer 8 is transmitted from third port 10 through second ring resonator 13 to first ring resonator 12, from which it is output through the second port again to the first port. No matter which path the light may travel through, entire loop waveguide 11 functions as a reflective optical filter. Therefore, the high reflectance end-face coating which has heretofore been required in the structure of the background art shown in FIG. 1 is dispensed with according to the present exemplary embodiment.

Normally, when light passes through an optical filter, it suffers a certain loss (insertion loss). In the structure of the background art shown in FIG. 1, after the light has passed through the two ring resonators, it is reflected by highly reflecting end face 55, and then passes through the two ring resonators again. If the laser wavelength is ideally in agreement with the transmission peaks of the ring resonators, then the loss caused by the ring resonators is nil. Actually, however, when the light travels circulatively along the rings or is optically coupled to an external port, an excessive loss is produced. While the light passes through the optical ring resonators four times in the structure of the background art, the light passes through the optical ring resonators only twice and hence suffers a reduced loss according to the present exemplary embodiment.

In the present exemplary embodiment, the light divided by 1×2 optical demultiplexer 8 returns through 1×2 optical demultiplexer 8 back to first port 7. Therefore, 1×2 optical demultiplexer 8 causes no optical loss.

Generally, a highly reflecting end coating film does not fully reflect 100% of light, but radiates several % of light, causing a loss. According to the present exemplary embodiment, the optical output is higher than with the background art because any loss is not caused in principle by a highly reflecting end face.

According to the present exemplary embodiment, furthermore, since no highly reflecting end coating film is required, the process of fabricating variable-wavelength filter substrate 6 is simplified, and the manufacturing cost of the optical filter is lowered. The cost is further reduced because the area of the optical filter is reduced.

According to the present exemplary embodiment, the external-resonator variable-wavelength laser employs 1×2 optical demultiplexer 8 shown in FIG. 2 to provide a simple structure. However, it may employ another optical circuit component such as a 2×2 optical demultiplexer or a 2×3 optical demultiplexer.

In the present exemplary embodiment, the light may be branched out of the loop waveguide from the loop waveguide or the optical ring resonator to monitor the optical intensity in the waveguide, as indicated by each of the modifications. The monitored optical intensity may be used to control the wavelength selection. For example, first monitoring waveguide 60 and second monitoring waveguide 61 shown in FIG. 4(A) can monitor the optical intensity.

First monitoring waveguide 60 serves as a port for extracting light out of first optical ring resonator 12, and is combined with first optical monitoring PD 62. Second monitoring waveguide 61 serves as a port for allowing second monitoring PD 63 to monitor the light branched from 2×2 optical demultiplexer 64. 2×2 optical demultiplexer 64 may set the optical intensity to be extracted out to a minimum level required by setting the optical intensity branching ratio to 1:9. First and second monitoring waveguides 60, 61 may be slanted at a few degrees to the end faces near the end faces, rather than being perpendicularly thereto, in order to reduce light reflections at the end faces of variable-wavelength filter substrate 6.

In the external-resonator variable-wavelength laser with the periodic channel selecting filter, the accuracy of the channel wavelength is determined to a certain extent by the FSR accuracy of the periodic channel selecting filter. In the present exemplary embodiment, the periodic channel selecting filter comprises first ring resonator 12. The accuracy of the periodic channel selecting filter may actually be not sufficient, and the periodic channel selecting filter itself may often be required to be variable in operation. Consequently, first ring resonator 12 may also include a variable mechanism for slightly changing the transmission wavelength. The accuracy of the wavelength in the passband may be increased by varying both first ring resonator 12 and second ring resonator 13. However, the laser oscillates at a wavelength where light phase conditions coincide with each other. Actually, therefore, a phase adjusting mechanism for adjusting the phase of the laser oscillation mode may be added to increase the accuracy of the laser oscillation wavelength. In the present exemplary embodiment, the phase adjusting mechanism comprises phase adjusting region 3. If, however, all of first ring resonator 12, second ring resonator 13, and phase adjusting region 3 are to be varied, it is not easy to bring the laser oscillation wavelength into agreement with the wavelength channel, and a certain monitoring mechanism is required to that end. Accordingly, it is preferable to provide a monitoring mechanism such as the monitoring waveguide and the monitoring PD in each of the modifications, and to perform variable control using information obtained by the monitoring mechanism.

First and second ring resonators 12, 13 according to the present exemplary embodiment may comprise any transmissive optical filter. For example, they may comprise known symmetrical or asymmetrical Mach-Zehnder interferometers. First optical filter 21 and second optical filter 22 which collectively refer thereto are conceptually illustrated in FIGS. 3(A) through 3(D). First optical filter 21 and second optical filter 22 may be of the same type or different types.

In the present exemplary embodiment, an optical filter may additionally be disposed in any position on the optical waveguide. Based on the Vernier effect due to FSRs of two different optical fibers, there is a single frequency at which light is transmitted maximally within the range of the least common multiple of FSRs. There is a certain instance where the least common multiple of two FSRs cannot be set to a value higher than a desired variable wavelength range, and no single transmission frequency is available.

Setting the least common multiple of FSRs to a value higher than a desired variable wavelength range means reducing the difference between FSRs of two optical filters. If Δf=FSR2−FSR1 is too small, then even when the transmission peak frequencies of the two optical filters agree with each other at frequency f1, a partial overlap is caused at an adjacent transmission peak wavelength, tending to produce an auxiliary mode affecting the laser operation. The shortcoming may be avoided by sufficiently reducing the widths of the transmission spectrums of the optical filters. However, if the width of the transmission spectrum is sufficiently reduced, then the allowable optical passband is reduced, and the frequency modulation efficiency for suppressing stimulated Brillouin scattering to be described later is reduced.

There are available two means for solving the above problems. The first solving means is a means for increasing FSRs themselves. For example, FSRs may be set to FSR1=500 gigahertz and FSR2=505 gigahertz. The least common multiple of these FSRs is 50500 gigahertz, thereby increasing the variable wavelength range ten times. In this case, □f=FSR2−FSR1 is 5 gigahertz, which is ten times Δf=0.5 gigahertz described above. This means that if the widths of the transmission spectrums of the optical filters are the same, then the overlap of the transmission spectrums of the two optical filters is small at a peak adjacent to the peak where the transmission spectrums of the two optical filters fully overlap each other, resulting in an increase in the auxiliary mode suppression ratio. At the same time, it means that there is still a margin available for increasing the widths of the transmission spectrums of the optical filters. For example, the widths of the transmission spectrums of the optical filters can be 2 to 5 times greater than the above example. As a result, this scheme is effective in increasing the frequency modulation efficiency and nevertheless preventing the auxiliary mode suppression ratio from being degraded. Increasing the widths of the transmission spectrums of the optical filters means reducing laser intensity modulation caused at the same time as the frequency modulation to an allowable range or less. The frequency of 500 gigahertz is given by way of example, and is not of restrictive nature.

According to the second solving means, a third optical filter is added according to a modification of the present exemplary embodiment. This scheme does not reduce the width of the transmission spectrum of each of the ring resonators and suppresses other modes regardless of the least common multiple of FSR1, FSR2. The third optical filter may be disposed on the loop waveguide, or may be disposed on the waveguide near the first port out of the loop, or may be disposed on both. The third optical filter may be a ring resonator or a symmetric or asymmetric Mach-Zehnder interferometer. The third optical filter is conceptually illustrated in FIGS. 3(B) through 3(D).

Depending on the design of wavelength selecting characteristics, the number of optical filters making up variable-wavelength filter substrate 6 may be at least two.

According to the present exemplary embodiment, since no waveguide directed to the highly reflecting end face is required, the overall optical path length may be shorter than with the background art. If the optical path length is reduced, then the laser mode intervals of the variable-wavelength laser combined with the semiconductor optical amplifier are increased to stabilize the laser oscillation mode. Details of the advantage will be described below.

Effective length L of an external resonator is defined as follows: Effective length L is defined as the sum of all products of refractive indexes ni and actual lengths L1 of components which make up a laser resonator, as expressed by the equation (2):

[Equation 2]

L=Σni×Li (2)

The Fabry-Perot interval that is determined by effective length L of the external resonator is expressed by the equation (3):

$$\begin{matrix}[ Equation 3 ] & \\ {Δ}_{cav} = \frac{{λ}^{2}}{2 nL} & ( 3 )\end{matrix}$$

where λ represents the laser wavelength and n the effective refractive index.

It is generally known from the equation (3) that as effective length L of the external resonator is greater, the Fabry-Perot interval is smaller, resulting in a reduction in the auxiliary mode suppression ratio of the laser. The structure according to the present exemplary embodiment is advantageous for mode stability because laser resonator length L is smaller than heretofore.

According to the present exemplary embodiment, the phase adjusting mechanism is disposed in the laser resonator in a preferred example. Since the phase adjusting mechanism is capable of finely adjusting effective length L of the resonator, it is possible to finely adjust the laser oscillation frequency (wavelength) within the passband of variable-wavelength filter substrate 6. If the laser oscillation frequency (wavelength) can be held in full agreement with the maximum transmission peak frequency (wavelength) of the optical filter, then the loss caused by variable-wavelength filter substrate 6 can be minimized.

Phase adjusting region 3 may be integrated together with semiconductor optical amplifier 1.

Normally, nonreflecting coating (AR coating) 20 is applied to the end face on the side of first port 7. The nonreflecting coating normally has a small remaining reflectance of less than 1%. According to the present exemplary embodiment, in order to further reduce the reflectance stably, the optical waveguide may emit the light at an angle different from the right angle with respect to the end face near the end face of the waveguide of first port 7. This structure can reduce disturbance of the external resonator laser oscillation mode due to the remaining reflectance at the end face of the semiconductor device.

In the present exemplary embodiment, if FSR1 of first optical filter 21 is in agreement with the standard channel frequency, then only second optical filter 22 may be varied. If the set wavelength of first optical filter 21 is not in agreement with the standard channel frequency with sufficient accuracy, then first optical filter 21 may be varied in addition to second optical filter 22, and the phase may be adjusted by the phase adjusting mechanism in the laser resonator for increased wavelength accuracy.

If a wavelength locker for stabilizing the wavelength is provided outside of the laser resonator, then the accuracy of the laser frequency with respect to a desired channel frequency is increased.

According to the present exemplary embodiment, since effective resonator length L can be smaller than heretofore, the laser oscillation wavelength (frequency) can be varied sensitively to a change in the refractive index of the phase adjusting region. As the frequency modulation efficiency for frequency-modulating the laser by modulating the phase adjusting current is higher than heretofore, it is possible to realize a laser with a reduced loss of optical fiber transmission due to stimulated Brillouin scattering in the optical fiber.

### 2nd Exemplary Embodiment

A second exemplary embodiment of the present invention will be described below.

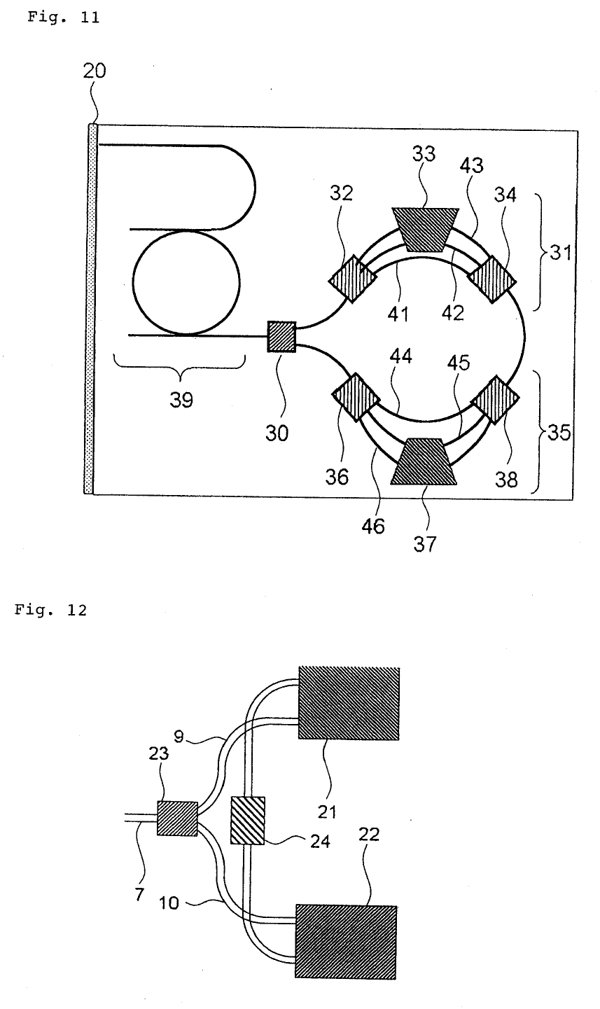

FIG. 11 is a schematic view showing the structure of a variable-wavelength filter substrate according to the second exemplary embodiment. An external-resonator variable-wavelength laser according to the second exemplary embodiment includes semiconductor device 1 which is identical in structure to the semiconductor device according to the first exemplary embodiment. According to the second exemplary embodiment, each of first and second optical filters on a variable-wavelength filter substrate comprises an AWG (Arrayed Waveguide Grating, array-type waveguide diffraction grating, phased array).

The AWG will be described in detail below. In FIG. 11, first AWG filter 31 and second AWG filter 35 are connected in the form of a loop to 1□2 MMI coupler 30. Each of first AWG filter 31 and second AWG filter 35 comprises an AWG made up of three waveguides. Generally, the number of waveguides of an AWG may be two or more. It is known that as the number of waveguides increases, one passband becomes narrower.

According to the present exemplary embodiment, a waveguide is divided into a plurality of waveguides which extend different distances and then are coupled into a single waveguide. With this structure, if the difference between optical paths of the waveguides is indicated by 2πn (n is an integer) where the wavelength λ of light beams passing through the waveguides is presented by phase 2π, then the light beams are coupled in phase with each other and all pass through the waveguide due to an interference effect. If the optical path difference is indicated by 2πn+π(n is an integer), then the light beams cancel each other and do not pass through the waveguide. Therefore, when the phase difference is varied, the transmission wavelength λ is varied. Specifically, the phase difference may be changed to vary the transmission wavelengths of the optical filters in the form of AWGs. In other words, the refractive index of the waveguide may be changed to develop different phase differences between the waveguides.

In FIG. 11, first AWG filter 31 comprises first 1×3 MMI coupler 32, second 1×3 MMI coupler 34, first AWG waveguide 41, second AWG waveguide 42, third AWG waveguide 43, and first heating resistor 33. First heating resistor 33 changes the refractive indexes in order to develop a phase difference of 2π between first AWG waveguide 41 and second AWG waveguide 42 and also to develop a phase difference of 2π between second AWG waveguide 42 and third AWG waveguide 43.

Second AWG filter 35 comprises third 1×3 MMI coupler 36, fourth 1×3 MMI coupler 38, fourth AWG waveguide 44, fifth AWG waveguide 45, sixth AWG waveguide 46, and second heating resistor 37. Second heating resistor 37 changes the refractive indexes thereby to develop a phase difference between fourth AWG waveguide 44 and fifth AWG waveguide 45 and also to develop a phase difference between fifth AWG waveguide 45 and sixth AWG waveguide 46.

According to the present exemplary embodiment, ring resonator 39 is provided as a third optical filter. The advantages of ring resonator 39 have been described above.

According to the present exemplary embodiment, since each of the first optical filter and the second optical filter comprises an AWG waveguide, the curvatures of the waveguides in each of the optical filters may be smaller than with the ring resonator, and a radiation loss of light at the curved regions may be reduced.

### 3rd Exemplary Embodiment

A third exemplary embodiment of the present invention will be described in detail with reference to FIG. 12.

FIG. 12 is a schematic view showing the structure of a variable-wavelength filter substrate according to the third exemplary embodiment. The variable-wavelength filter substrate according to the third exemplary embodiment includes first port 7, 1×2 optical demultiplexer 23, second port 9, third port 10, first optical filter 21, and second optical filter 22 which are identical in structure to those according to the modification of the first exemplary embodiment shown in FIG. 3(B).

According to the third exemplary embodiment, first and second optical filters 21, 22 have output ports are disposed on the side of 1×2 optical demultiplexer 23. Therefore, the waveguide between first optical filter 21 and third optical filter 24 crosses second port 9, and the waveguide between second optical filter 22 and third optical filter 24 crosses third port 10.

With the layout according to the third exemplary embodiment, the light travels in a loop in the same manner as with the structure shown in FIG. 3(B). The waveguides can thus be laid out with freedom, and no problem arises even if the waveguides cross each other. Specifically, in FIG. 12, first filter 21 may comprise a ring resonator, second filter 22 a ring resonator, and third filter 24 an asymmetrical Mach-Zehnder interferometer. The selection of the optical filters makes it possible to provide the layout as shown FIG. 12.

### 4th Exemplary Embodiment

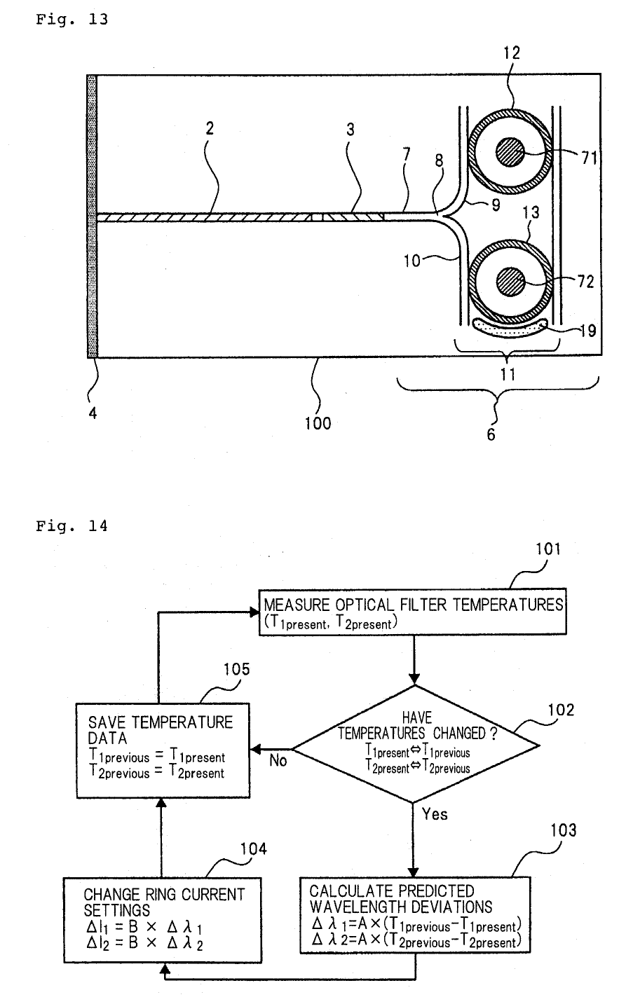

Δfourth exemplary embodiment of the present invention will be described in detail with reference to FIG. 13.

FIG. 13 is a schematic view showing the structure of an external-resonator laser comprising an integrated assembly of variable-wavelength filters according to the fourth exemplary embodiment. In FIG. 13, semiconductor amplifier 2, phase adjusting region 3, and variable-wavelength filter 6 are integrated on one semiconductor indium phosphide (InP) substrate 100.

Since the integrated assembly of the semiconductor amplifier and the variable-wavelength filter can fully eliminate any optical coupling loss in a coupler, the laser light output can be increased. With the semiconductor amplifier and the variable-wavelength filter being integrated on one substrate, no manufacturing step is required to optically couple the semiconductor amplifier and the phase adjusting region or the variable-wavelength filter, resulting in a reduction in the cost of the laser.

Furthermore, as variable-wavelength filter 6 is made of semiconductor indium phosphide (InP), the refractive index of the optical filter can be changed under heat control based on resistance heating or current control. Current control makes it possible to vary the wavelength faster than heat control.

Normally, semiconductor device 100 is mounted on a temperature controller (TEC) and controlled so as to be kept at a certain constant temperature. Since the temperature of semiconductor device 100 is constant even when the ambient temperature changes, the laser wavelength remains substantially unchanged. On the semiconductor substrate, the temperature may locally change due to a change in the ambient temperature, possibly varying the wavelength slightly.

For controlling the wavelength of the optical filter more accurately, it is preferable to monitor the temperature of each optical filter. In FIG. 13, first thermistor 71 is disposed in the vicinity of first filter 12, and second thermistor 72 is disposed in the vicinity of first filter 13. If the optical filters are in the form of rings as shown in FIG. 13, the thermistors should preferably be disposed near the centers of the rings in order to equalize the distances between the thermistors and the ring waveguides.

According to the fourth exemplary embodiment, the laser wavelength can be kept constant to a certain extent even if a temperature controller (TEC) is not employed. A control flow of such a process will be described below. FIG. 14 is a flowchart showing a process of adjusting temperature under current control according to the fourth exemplary embodiment. As shown in FIG. 14, first thermistor 71 and second thermistor 72 measure optical filter temperatures (step 101), and determine whether there are temperature changes or not (step 102).

If either one of first thermistor 71 and second thermistor 72 detects a temperature change, then predicted values of wavelength deviations due to the temperature change are calculated (step 103). Specifically, temperature changes from previous temperatures (T1 previous, T2 previous) stored in a memory to present temperatures (T1 present, T2 present) are multiplied by a predetermined temperature-dependent coefficient A (nm/1C) to calculate predicted values (Δλ1, Δλ2) of wavelength deviations.

Then, corrective quantities for ring current settings are calculated from the predicted values of wavelength deviations (step 104), and the current settings for the optical filters are changed by the corrective quantities according to feedback. Specifically, the predicted values (Δλ1, Δλ2) of wavelength deviations are multiplied by a predetermined current coefficient B (mA/nm) to calculate corrective quantities (ΔI1, ΔI2) for ring current settings.

After step 104 or if no temperature change is judged in step 102, the measured temperature data are recorded in the memory (step 105).

According to the present exemplary embodiment, the wavelength can be controlled at a constant level at all the times without the need for a temperature controller. Since no temperature controller is required, the cost of the variable-wavelength laser and the power consumption thereof are expected to be lowered.

In the present exemplary embodiment, the optical filters are energized under current control. However, even if the optical filters are energized under heat control, they can be controlled according to feedback.

1-19. (canceled)

20. A variable-wavelength filter for varying a wavelength at which light is transmitted, comprising:
an optical circuit component for dividing light input from an external device into at least two ports; and
a loop waveguide interconnecting at least said ports divided by said optical circuit component in the form of a loop, with at least two wavelength selecting filters inserted in series in a path of said loop waveguide, said wavelength selecting filters having periodic transmission characteristics on a frequency axis which are different from each other, and an asymmetrical Mach-Zehnder interferometer having periodic transmission characteristics on a frequency axis, at least one of said wavelength selecting filters being capable of varying a selected wavelength, the transmission characteristics of said asymmetrical Mach-Zehnder interferometer having a period which is represented by about the least common multiple of the periods of the transmission characteristics of said at least two wavelength selecting filters.

21. A variable-wavelength filter according to claim 20, wherein said asymmetrical Mach-Zehnder interferometer is inserted in the path connected in the form of said loop in said variable-wavelength filter.

22. A variable-wavelength filter according to claim 20, wherein said asymmetrical Mach-Zehnder interferometer inserted between said external device and said optical circuit component.

23. A variable-wavelength filter according to claim 21 or 22, wherein a selected wavelength of said asymmetrical Mach-Zehnder interferometer can be varied.

24. A variable-wavelength filter according to claim 21 or 22, wherein each of said wavelength selecting filters comprises a ring resonator.

25. A variable-wavelength filter according to claim 21 or 22, further comprising a first monitoring mechanism for dividing and outputting a portion of the light from said loop waveguide.

26. A variable-wavelength filter according to claim 21 or 22, further comprising a second monitoring mechanism for dividing and outputting a portion of the light from a waveguide between said external device and said optical circuit component.

27. A variable-wavelength laser comprising:
a variable-wavelength filter according to claim 21 or 22; and
a semiconductor device including an optical amplifier for generating light when a current is introduced thereinto, said semiconductor device being coupled to said variable-wavelength filter and serving as said external device for inputting light to said variable-wavelength filter.
